(19) United States
(12) Patent Application Publication
(10) Pub. No.: US 2025/0183462 A1
(43) Pub. Date: Jun. 5, 2025

(54) ENERGY STORAGE APPARATUS

(71) Applicant: GS Yuasa International Ltd., Kyoto-shi (JP)

(72) Inventors: Yosuke NISHIMURA, Kyoto-shi (JP); Kosuke HAYASHI, Kyoto-shi (JP); Ryosuke FUJII, Kyoto-shi (JP)

(73) Assignee: GS Yuasa International Ltd., Kyoto-shi (JP)

(21) Appl. No.: 18/832,391

(22) PCT Filed: Jan. 19, 2023
(86) PCT No.: PCT/JP2023/001438

§ 371 Date: Feb. 11, 2025

(30) Foreign Application Priority Data
Jan. 26, 2022 (JP) 2022-009985

(51) Int. Cl. H01M 50/296; H01G 11/10; H01M 50/209; H01M 50/507

(52) U.S. Cl. CPC H01M 50/296; H01M 50/209; H01M 50/507; H01G 11/10

(57) ABSTRACT

An energy storage apparatus of the present embodiment includes at least one energy storage device, a terminal member aligned with the at least one energy storage device in a predetermined direction, a connector which is connected to the at least one energy storage device in an electrically conductive manner and performs electrical input and output with an outside, and a plurality of linking parts which fix the connector to the terminal member. The plurality of linking parts include at least one linking part made of resin.

### TECHNICAL FIELD

The present invention relates to an energy storage apparatus including an energy storage device.

### BACKGROUND ART

Conventionally, there has been known an assembled battery apparatus including a plurality of battery cells, a spacer member that separates the battery cells, a case that is a housing that houses all the battery cells together with the spacer member, and a plurality of bus bars that electrically connect the battery cells (see Patent Document 1).

In the assembled battery apparatus, the bus bar functions as an external output terminal, and is connected to a terminal block. As illustrated in FIGS. 16 and 17, the terminal block 900 includes a placing table 901 and a pressing member 902.

On the placing table 901, a groove 901a is formed substantially at the center thereof, through holes 901b and 901c are provided at both ends of the upper surface with the groove 901a interposed therebetween, and a screw hole 901d serving as a female screw is formed in the bottom surface of the groove 901a.

The pressing member 902 is formed in a rectangular plate shape, through holes 902a and 902b are provided at both ends of the pressing member 902, and a through hole 902c is also provided at the center between the through holes. The pressing member 902 is placed on the placing table 901 so as to cross the groove 901a. In this state, the through hole 902a is located on the same straight line as the through hole 901b, the through hole 902b is located on the same straight line as the through hole 901c, and the through hole 902c is located on the same straight line as the screw hole 901d.

Here, a through hole H1 is formed in an end portion of a bus bar 905A, and a through hole H2 is also formed in an end portion of an external bus bar 905C. The bus bar 905A and the external bus bar 905C are electrically connected via the terminal block 900. First, the through hole H1 of the bus bar 905A is aligned with the screw hole 901d in the groove 901a of the placing table 901, the end of the bus bar 905A is fitted into the groove 901a of the placing table 901, and the pressing member 902 is stacked thereon. Thereafter, the two screws 906 and 907 pass through the through holes 902a and 902b of the pressing member 902 and the through holes 901b and 901c of the placing table 901, respectively, and are rotated into screw holes (not shown) serving as female screws formed on the surface of the upper case 910, whereby the terminal block 900 is fixed to the surface of the upper case 910.

Then, in the above-described state, the through hole H2 of the external bus bar 905C is aligned with the through hole 902c of the pressing member 902, and the end portion of the external bus bar 905C is placed on the pressing member 902. Then, the screw 908 passes through the through hole 902c of the pressing member 902 and the through hole H1 of the bus bar 905A, and is rotated into the screw hole 901d of the placing table 901. As a result, the bus bar 905A and the external bus bar 905C are fastened and fixed to the placing table 901 by the screw 908 via the pressing member 902.

When the terminal block 900 is removed from the case in disassembling the assembled battery apparatus configured as described above, it is necessary to remove each of the plurality of small screws 906, 907, and 908, which is complicated. Even when the screws 906, 907, and 908 are removed by breaking or the like, work of breaking or the like is troublesome because each of the plurality of screws 906, 907, and 908 is made of metal.

### PRIOR ART DOCUMENTS

### Patent Documents

Patent Document 1: JP-A-2012-134092

### SUMMARY OF THE INVENTION

### Problems to be Solved by the Invention

An object of the present embodiment is to provide an energy storage apparatus which is easily disassembled.

### Means for Solving the Problems

An energy storage apparatus of the present embodiment includes:
at least one energy storage device;
a terminal member aligned with the at least one energy storage device in a predetermined direction;
a connector which is connected to the at least one energy storage device in an electrically conductive manner and performs electrical input and output with an outside; and
a plurality of linking parts which fix the connector to the terminal member.

The plurality of linking parts include at least one linking part made of resin.

### Advantages of the Invention

As described above, according to the present embodiment, it is possible to provide an energy storage apparatus which is easily disassembled.

### BRIEF DESCRIPTION OF THE DRAWINGS

FIG. 1 is a perspective view of an energy storage apparatus according to the present embodiment.

FIG. 2 is an exploded perspective view in which a part of the configuration of the energy storage apparatus is omitted.

FIG. 3 is a view of a terminal member included in the energy storage apparatus as viewed in the X-axis direction.

FIG. 4 is a perspective view of the terminal member.

FIG. 5 is a perspective view of the terminal member.

FIG. 6 is a cross-sectional view taken along line VI-VI in FIG. 3.

FIG. 7 is a view of a connector as viewed in an X-axis direction.

FIG. 8 is a perspective view of the connector when a cover member is at a closed position.

FIG. 9 is a perspective view of the connector when the cover member is at a closed position.

FIG. 10 is a perspective view of the connector when the cover member is at an open position.

FIG. 11 is a cross-sectional view taken along line XI-XI in FIG. 7.

FIG. 12 is an enlarged view of the connector and a peripheral portion thereof as viewed from one side in the Z-axis direction.

FIG. 13 is a cross-sectional view taken along line XIII-XIII of FIG. 12.

FIG. 14 is a view for describing a mounting direction of the connector to the terminal member.

FIG. 15 is a view for describing a mounting direction of the connector to the terminal member.

FIG. 16 is an exploded perspective view for describing a configuration of a conventional terminal block and a connection state of a bus bar.

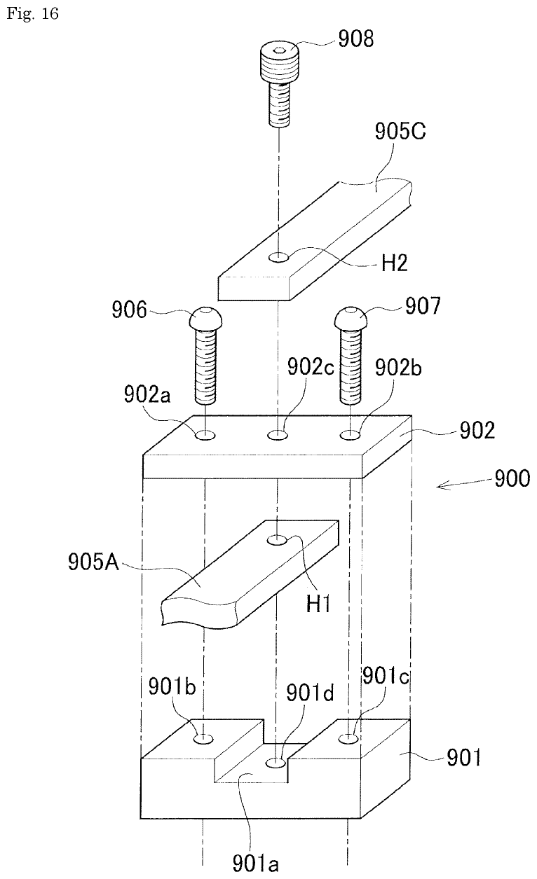

FIG. 17 is a cross-sectional view of the terminal block in a state where the bus bar is connected.

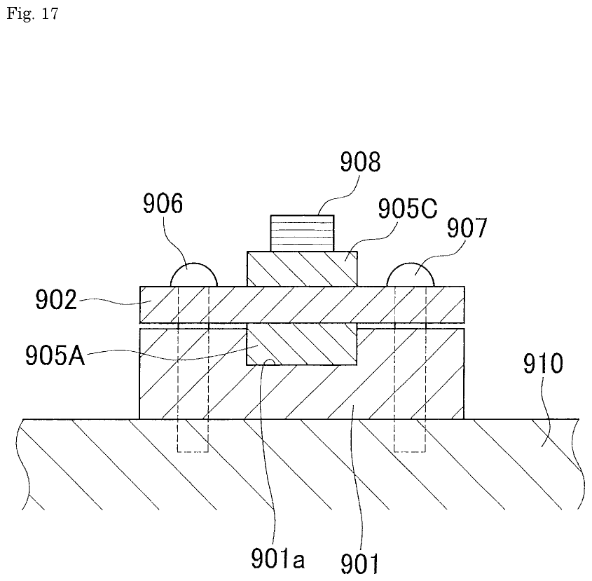

### MODE FOR CARRYING OUT THE INVENTION

(1) An energy storage apparatus according to the present embodiment includes:
at least one energy storage device;
a terminal member aligned with the at least one energy storage device in a predetermined direction;
a connector which is connected to the at least one energy storage device in an electrically conductive manner and performs electrical input and output with an outside; and
a plurality of linking parts which fix the connector to the terminal member.

The plurality of linking parts include at least one linking part made of resin.

According to such a configuration, since at least one linking part of the plurality of linking parts is a resin-made linking part which can be easily broken or the like by a cutting tool such as a nipper, the energy storage apparatus is easily disassembled.
(2) In the energy storage apparatus described in (1) above, in the energy storage apparatus,
the connector may include a terminal having conductivity and a connector main body made of resin and holding the terminal,
the at least one linking part made of resin may be formed of a protruding part extending from the connector main body,
the terminal member may include a through hole at a position corresponding to the protruding part, and
the protruding part extending from the connector main body may be engaged with a peripheral edge portion of the through hole in a state where the protruding part is inserted into the through hole of the terminal member.

According to such a configuration, since the protruding part forming the linking part is made of resin, the protruding part can be easily broken or the like.
(3) In the energy storage apparatus according to (1) or (2) above, the energy storage apparatus may further include:
an extending member extending in the predetermined direction along the at least one energy storage device; and
a linking member which links the terminal member and the extending member.

The terminal member may be disposed between the at least one energy storage device and the connector in the predetermined direction,
a part or whole of the connector may be disposed at a position overlapping the terminal member when viewed from the predetermined direction,
a part or whole of the linking member may be located between the terminal member and the connector, and may be disposed at a position overlapping the connector when viewed from the predetermined direction, and
one linking part of the plurality of linking parts may include a through shaft which penetrates the connector and the terminal member in a penetrating direction and extends in the penetrating direction, and link the connector and the terminal member so as to allow the connector to be rotatable about the through shaft with respect to the terminal member.

With such a configuration, the link between the terminal member and the extending member can be released without releasing all the links formed by the plurality of linking parts and hence, the energy storage apparatus can be easily disassembled. That is, although the linking member is hidden by the connector main body in the energy storage apparatus, if the links by the other linking parts are released while the linking part including the through shaft is left, it is possible to expose the linking member by rotating the connector around the through shaft with respect to the terminal member. As a result, the operator or the like can easily access the linking member, so that the link between the terminal member and the extending member can be easily released.
(4) In the energy storage apparatus according to any one of (1) to (3) above, in the energy storage apparatus,
the plurality of linking parts may include at least one linking part made of metal.

As described above, since the plurality of linking parts include a linking part made of resin and a linking part made of metal, it is easy to balance ease of disassembly and securing of linking strength.
(5) In the energy storage apparatus according to (4) above, the at least one linking part made of metal may be a rivet, and
the at least one linking part made of resin may link the connector and the terminal member so as to position portions of the connector and the terminal member linked to each other by the rivet.

With such a configuration, it is easy to assemble the energy storage apparatus. That is, when the energy storage apparatus is assembled, the connector and the terminal member are linked to each other by the at least one linking part made of resin so that portions of the connector and the terminal member which are connected to each other by the rivet are positioned. Therefore, linking by the rivet can be made easily.
(6) In the energy storage apparatus according to any one of (1) to (5) above, in the energy storage apparatus
three or more of the linking parts may be disposed, and
the three or more linking parts may include three or more types of linking parts having different configurations.

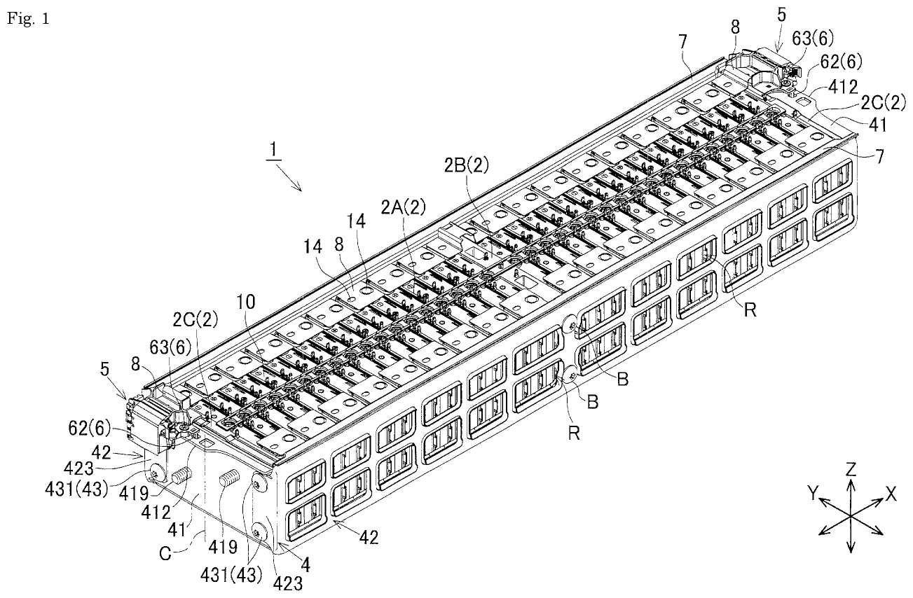

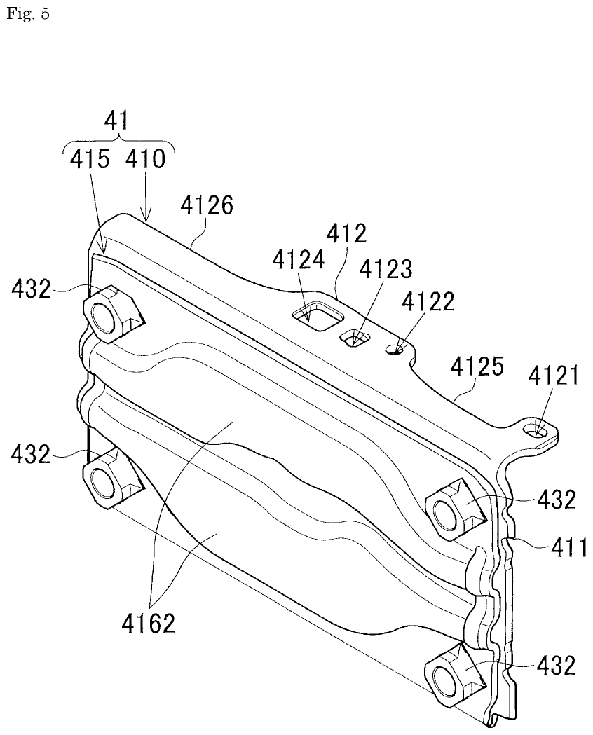

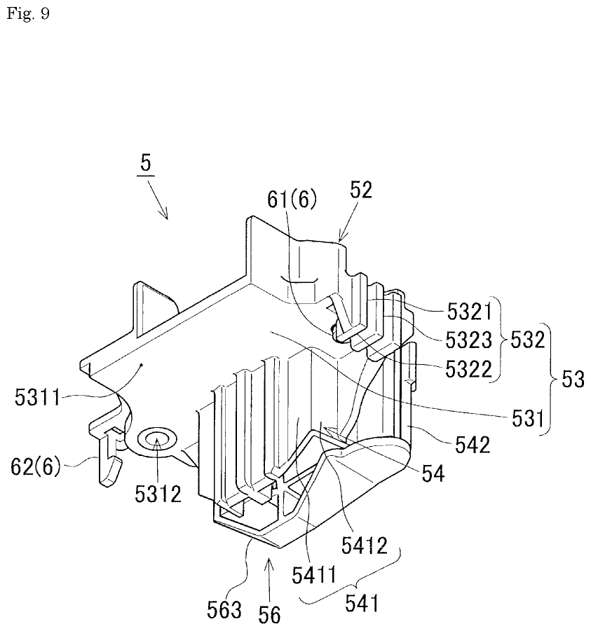

Hereinafter, an embodiment of the present invention will be described with reference to FIGS. 1 to 15. Note that the names of the constituent members (constituent elements) of the present embodiment are those in the present embodiment, and may be different from the names of the constituent members (constituent elements) in the background art.

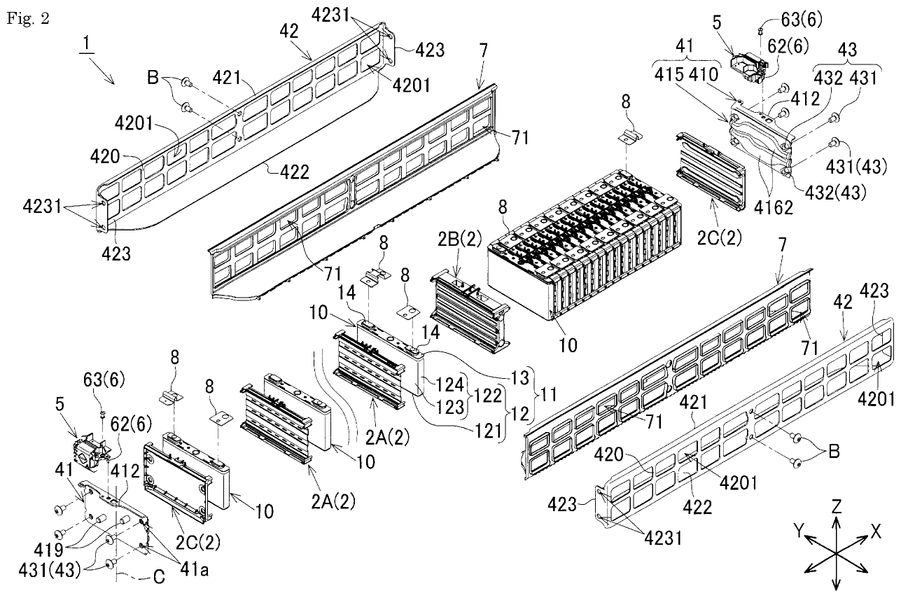

As shown in FIGS. 1 and 2, the energy storage apparatus 1 of the present embodiment includes at least one energy storage device 10, a terminal member 41 arranged side by side with the at least one energy storage device 10, at least one connector 5 which is connected to the at least one energy storage device 10 in an electrically conductive manner and performs electrical input and output with the outside, and a plurality of linking parts 6 which fix the connector 5 to the terminal member 41. Specifically, the energy storage apparatus 1 includes a plurality of energy storage devices 10 arranged in a predetermined direction, a plurality of adjacent members 2 which are disposed adjacently to the energy storage devices 10 in the predetermined direction, a holding member 4 which includes a terminal member 41 and holds the plurality of energy storage devices 10 and the plurality of adjacent members 2, at least one connector 5, and a plurality of linking parts 6. The energy storage apparatus 1 includes a first fastening member B which fixes at least one adjacent member 2 to the holding member 4, at least one insulator 7 which insulates the plurality of energy storage devices 10 and the holding member 4 from each other, and a plurality of bus bars 8 which connect the different energy storage devices 10 to each other or connect the connector 5 and the energy storage devices 10 to each other in an electrically conductive manner.

Each of the plurality of energy storage devices 10 is a primary battery, a secondary battery, a capacitor, or the like. The energy storage device 10 of the present embodiment is a nonaqueous electrolyte secondary battery which can be charged and discharged. More specifically, the energy storage device 10 is a lithium ion secondary battery utilizing electron transfer caused by transfer of lithium ions.

To be more specific, each energy storage device 10 includes an electrode assembly, a case 11 which houses the electrode assembly together with an electrolyte solution, an external terminal 14 which is partially or entirely exposed to the outside of the case 11, and a current collector which connects the electrode assembly and the external terminal 14 to each other.

In the electrode assembly, a positive electrode and a negative electrode are alternately layered with a separator interposed therebetween. In this electrode assembly, lithium ions move between the positive electrode and the negative electrode, whereby the energy storage device 10 is charged and discharged.

The case 11 includes a case body 12 having an opening, and a plate-like lid plate 13 that covers (closes) the opening of the case body 12. The case body 12 has a rectangular tube shape (that is, a bottomed rectangular tube shape) in which one end portion in the opening direction is covered, and the case 11 has a rectangular parallelepiped shape (hexagonal shape).

Specifically, the case body 12 includes a plate-shaped closing part 121 and a cylindrical body part (peripheral wall) 122 connected to a peripheral edge of the closing part 121.

The closing part 121 is a portion positioned at a lower end of the case body 12 when the case body 12 is disposed in a posture in which the opening faces upward (that is, serving as a bottom wall of the case body 12 when the opening faces upward). The closing part 121 has a rectangular shape when viewed from the normal direction of the closing part 121.

The body part 122 has a rectangular tube shape, more specifically, a flat rectangular tube shape. The body part 122 includes a pair of long walls 123 extending from long sides of the peripheral edge of the closing part 121, and a pair of short walls 124 extending from short sides of the peripheral edge of the closing part 121. In the body part 122, the short wall 124 connects the corresponding end portions of the pair of long walls 123 to each other to form the body part 122 having a rectangular tube shape.

The lid plate 13 is a plate-like member which covers the opening of the case body 12. The lid plate 13 of the present embodiment has a rectangular shape. The lid plate 13 is joined to the case body 12 in a state where the peripheral edge portion of the lid plate 13 is overlapped with the peripheral edge portion of an opening of the case body 12, whereby the case 11 is formed.

The case 11 described above has a flat rectangular parallelepiped shape, and the plurality of energy storage devices 10 are arranged in the predetermined direction in a state where wide surfaces (long walls 123) of the case 11 face each other.

The external terminal 14 is a portion which is electrically connected to an external terminal of another energy storage device, an external device, or the like. The external terminal 14 is formed of a conductive member. For example, the external terminal 14 is formed of a metal material having high weldability, such as an aluminum-based metal material such as aluminum or an aluminum alloy, or a copper-based metal material such as copper or a copper alloy. The energy storage device 10 of the present embodiment includes two external terminals 14 and are disposed on both end portions of the lid plate 13 in the longitudinal direction.

In the following description, it is assumed that a direction (predetermined direction) in which the plurality of energy storage devices 10 are arranged is an X axis of an orthogonal coordinate system, a direction in which the short walls 124 of the case 11 face each other is a Y axis of the orthogonal coordinate system, and a direction in which the lid plate 13 and the closing part 121 face each other is a Z axis of the orthogonal coordinate system.

The adjacent member 2 has an insulating property, and is disposed between the energy storage devices 10 aligned in the X-axis direction or between the energy storage device 10 and a member (in the example of the present embodiment, a part of the holding member 4) aligned with the energy storage device 10 in the X-axis direction. The adjacent member 2 of the present embodiment is formed of resin. The adjacent member 2 forms a flow path R through which a temperature adjusting fluid (a gas such as air in the example of the present embodiment) can flow between the adjacent member 2 and the adjacent energy storage device 10. The energy storage apparatus 1 of the present embodiment includes the plurality of adjacent members 2, and the plurality of adjacent members 2 include a plurality of kinds of adjacent members 2A, 2B, and 2C.

To be more specific, the plurality of adjacent members 2 include: a first adjacent member 2A which is disposed between two energy storage devices 10 disposed adjacently to each other; a second adjacent member 2B which is disposed between the energy storage devices 10 disposed adjacently to each other and is fixed to the holding member 4; and a third adjacent member 2C which is disposed between the holding member 4 and the energy storage device 10 disposed at the outermost end in the X-axis direction and is disposed adjacently to the energy storage device 10. That is, the energy storage apparatus 1 includes the first adjacent member 2A, the second adjacent member 2B, and the third adjacent member 2C as the adjacent members 2. The energy storage apparatus 1 of the present embodiment includes a plurality of first adjacent members 2A, one second adjacent member 2B, and two (a pair of) third adjacent members 2C. Each of the plurality of first adjacent members 2A is disposed between the energy storage devices 10 except for a portion between the energy storage devices 10 where the second adjacent member 2B is disposed.

The holding member 4 collectively holds the plurality of energy storage devices 10 and the plurality of adjacent members 2 by surrounding the peripheries of the plurality of energy storage devices 10 and the plurality of adjacent members 2. The holding member 4 is made of a conductive member such as metal.

To be more specific, the holding member 4 includes: a pair of terminal members 41 which is disposed on both sides of the plurality of energy storage devices 10 (layered product of the energy storage devices 10) in the X-axis direction; an extending member 42 which extends in the X-axis direction along the plurality of energy storage devices 10; and linking members 43 which connect the terminal members 41 and the extending member 42 to each other. More specifically, the holding member 4 of the present embodiment includes a pair of extending members 42, and the pair of extending members 42 is disposed on both sides of the plurality of energy storage devices 10 in the Y-axis direction to connect the pair of terminal members 41. The holding member 4 of the present embodiment includes a plurality of linking members 43.

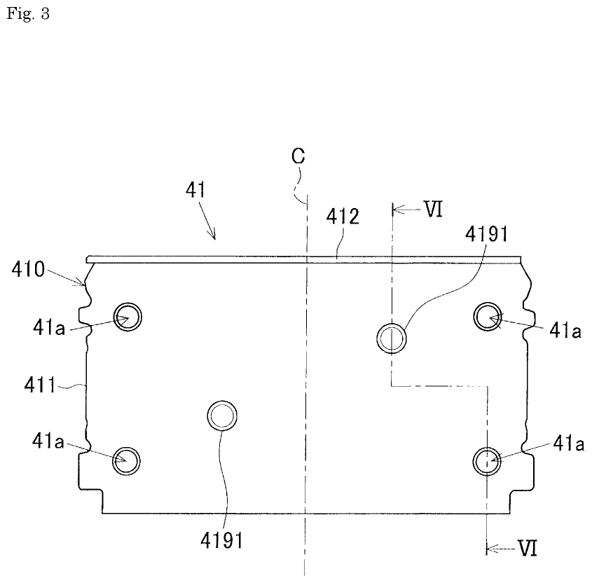

Each of the pair of terminal members 41 is disposed so as to sandwich the third adjacent member 2C between the terminal member and the energy storage device 10 disposed at an end (outermost side) in the X-axis direction. As also shown in FIGS. 3 to 6, each of the pair of terminal members 41 has a rectangular plate shape having a size corresponding to the size of the energy storage device 10, and includes linking through holes 41a penetrating in the X-axis direction at four corners. That is, the terminal member 41 includes four linking through holes 41a. The four linking through holes 41a are used for linking the terminal members 41 and the extending members 42.

To be more specific, each of the terminal members 41 includes a first member 410 and a second member 415 which are arranged in a row in a direction approaching the energy storage device 10 in the X-axis direction, and has a rectangular shape elongated in the Y-axis direction as viewed in the X-axis direction. Each terminal member 41 of the present embodiment includes a plurality of fixing portions 419 extending from the first member 410 along the X-axis direction.

The first member 410 includes: a plate-like first member body 411 which expands in a direction orthogonal to the X-axis direction; and a flange portion 412 which extends in a direction away from the energy storage device 10 in the X-axis direction from the first member body 411.

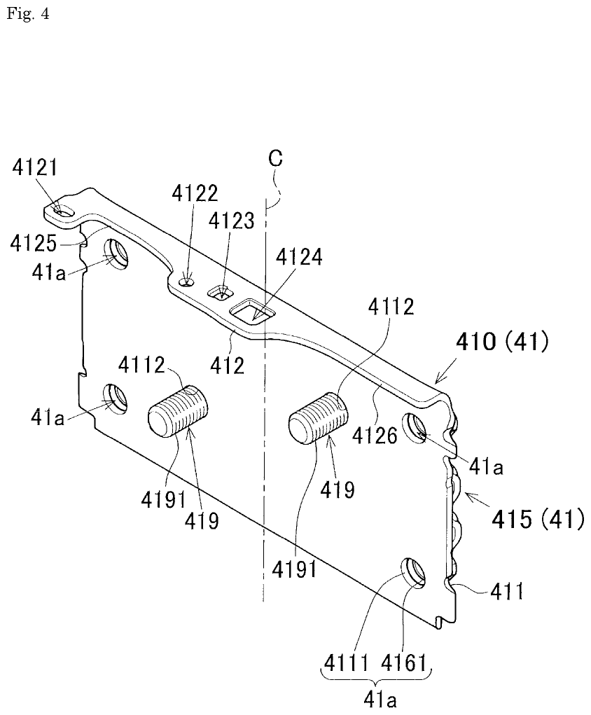

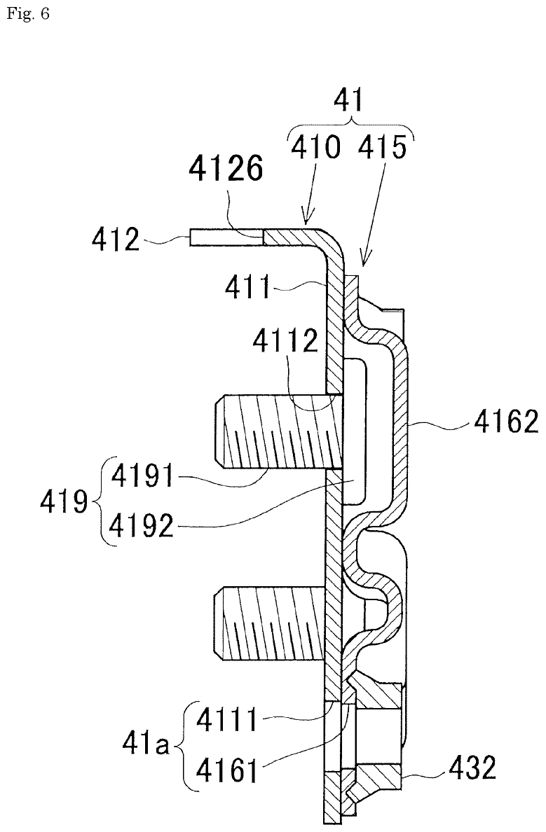

The first member body 411 has a rectangular shape corresponding to the energy storage device 10 as viewed in the X-axis direction, more specifically, a rectangular shape elongated in the Y-axis direction. The first member body 411 includes first linking through holes 4111 penetrating in the X-axis direction at four corners (that is, each rectangular corner portion) (see FIGS. 4 and 6). That is, the first member body 411 includes the four first linking through holes 4111. The first member body 411 includes two fixing portion through holes 4112 penetrating in the X-axis direction on the center C side (inner side) with respect to the first connecting through holes 4111 at both ends of the first member body 411 in the Y-axis direction. These two fixing portion through holes 4112 are disposed at intervals in the diagonal direction of the first member body 411.

The flange portion 412 is a plate-like portion which extends in a direction away from the energy storage device 10 in the X-axis direction from one end portion (an upper portion in FIG. 3) of the first member body 411 in the Z-axis direction, and extends in the Y-axis direction. In the flange portion 412, a first through hole 4121, a second through hole 4122, and a third through hole 4123 are disposed in this order from one end (end portion where the connector 5 is disposed: left end portion in the example illustrated in FIG. 4) toward the other end in the Y-axis direction. The flange portion 412 of the present embodiment includes a fourth through hole 4124 at a position closer to the other end than the third through hole 4123. Each of the through holes 4121, 4122, 4123, 4124 penetrates in the Z-axis direction.

The flange portion 412 includes, between the first through hole 4121 and the second through hole 4122 in the Y-axis direction, a first notch 4125 which is notched so as to be recessed in a direction approaching the energy storage device 10 in the X-axis direction, and a second notch 4126 which is notched from the fourth through hole 4124 to the other end portion in the Y-axis direction. In the first notch 4125, the depth in the recessed direction (dimension in the X-axis direction) decreases from the first through hole 4121 toward the second through hole 4122.

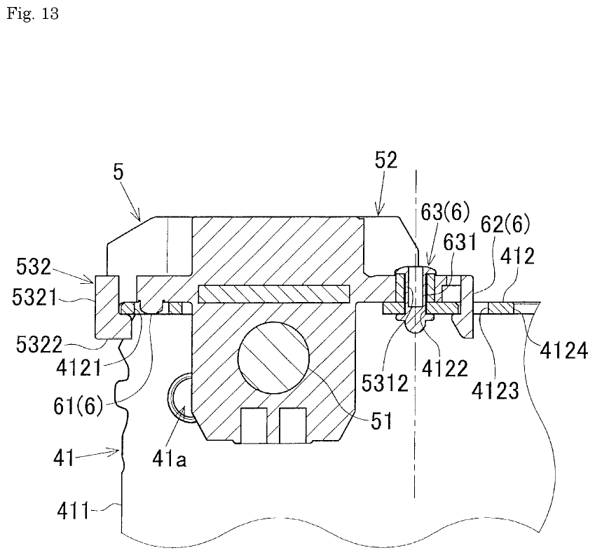

The first through hole 4121 is a circular (so-called racetrack shape) hole that is long in the Y-axis direction, and a part 61 of the connector 5 (see FIG. 13) is press-fitted into the first through hole. The second through hole 4122 is a circular hole through which a member 63 that links the connector 5 to the terminal member 41 is inserted. The third through hole 4123 is a quadrangular hole, and a peripheral edge portion of the third through hole 4123 in the flange portion 412 (a peripheral edge portion of the through hole) is engaged with a part 62 of the connector 5. The fourth through hole 4124 is a quadrangular hole and is larger than the third through hole 4123.

The second member 415 has a rectangular shape corresponding to the first member body 411 of the first member 410 as viewed in the X-axis direction, more specifically, a rectangular contour elongated in the Y-axis direction, and is overlapped with the first member 410. The second member 415 extends along the first member body 411. The second member 415 includes second connecting through holes 4161 penetrating in the X-axis direction at four corners (that is, each rectangular corner portion) (see FIGS. 4 and 6). That is, the second member 415 includes the four second linking through holes 4161. Each of the four second linking through holes 4161 overlaps with each of the first linking through holes 4111 disposed at the four corners of the first member body 411 as viewed in the X-axis direction. With such a configuration, the first connecting through hole 4111 formed in the first member body 411 and the second connecting through hole 4161 formed in the second member 415 are formed continuously with each other in the X-axis direction and hence, a connecting through hole 41a in the terminal member 41 is formed.

The second member 415 includes a plurality of (in the example of the present embodiment, two) protruding parts 4162 protruding in a direction approaching the energy storage devices 10 in the X-axis direction. Each of the plurality of protruding parts 4162 extends in the Y-axis direction and is disposed at an interval in the Z-axis direction. The protruding part 4162 of the present embodiment is formed by drawing.

The plurality of fixing portions 419 include: a shaft 4191 which extends (in other words, protrudes) in a direction away from the energy storage device 10 in the X-axis direction from the first member body 411 through the fixing portion through hole 4112 of the first member body 411; and a head portion 4192 which expands in a direction orthogonal to the X-axis direction from the shaft 4191 between the first member 410 and the second member 415 in the X-axis direction (see FIG. 6). The head portion 4192 is larger than the fixing portion through hole 4112. The shaft 4191 has a male screw on the peripheral surface. The fixing portion 419 is used to fix the energy storage apparatus 1 when the energy storage apparatus 1 is mounted on a vehicle, an apparatus, or the like.

Returning to FIGS. 1 and 2, each of the pair of extending members 42 includes an extending member body 420 facing the short wall 124 of each energy storage device 10, a first piece part 421 extending in the Y-axis direction along the lid plate 13 of each energy storage device 10 and extending in the X-axis direction from one end portion in the Z-axis direction of the extending member body 420, a second piece part 422 extending in the Y-axis direction along the closing part 121 of each energy storage device 10 and extending in the X-axis direction from the other end portion in the Z-axis direction of the extending member body 420, and a pair of third piece parts 423 extending in the Y-axis direction along the terminal member 41 and extending in the Z-axis direction from each end portion in the X-axis direction of the extending member body 420.

The extending member body 420 has a plate shape extending along the short wall 124 of each energy storage device 10, and has a plurality of through holes 4201 penetrating in the Y-axis direction so that the temperature regulating fluid can flow into or flow out of each flow path R.

The first piece part 421 has a band shape elongated in the X-axis direction, and has a constant dimension (width) in the Y-axis direction at each position excluding both end portions in the X-axis direction. The second piece part 422 has a band shape elongated in the X-axis direction, and has a constant dimension (width) in the Y-axis direction at each position excluding both end portions in the X-axis direction. In the Y-axis direction, the width of the second piece part 422 is larger than the width of the first piece part 421. Each of the pair of third piece parts 423 includes two through holes 4231 disposed at intervals in the Z-axis direction. Each of the through holes 4231 is disposed at a position corresponding to the linking through hole 41a (through hole in which the first connecting through hole 4111 of the first member body 411 and the second connecting through hole 4161 of the second member 415 are formed continuously with each other) of the terminal member 41.

Each of the plurality of linking members 43 fastens the terminal member 41 and the extending member 42 in a state of being inserted through the linking through hole 41a of the terminal member 41 and the through hole 4231 of the extending member 42 (to be more specific, the third piece part 423). Each of the linking members 43 of the present embodiment is configured of a bolt 431 and a nut 432.

The at least one connector 5 is connected to the energy storage device 10 (to be more specific, the external terminal 14 of the energy storage device 10) in an electrically conductive manner, and performs electrical input and output with the outside. The energy storage apparatus 1 of the present embodiment includes two connectors, that is, a connector 5 to which input from the outside is performed and a connector 5 to which output to the outside is performed. Since the two connectors 5 have the same configuration, the configuration of one connector 5 will be described below.

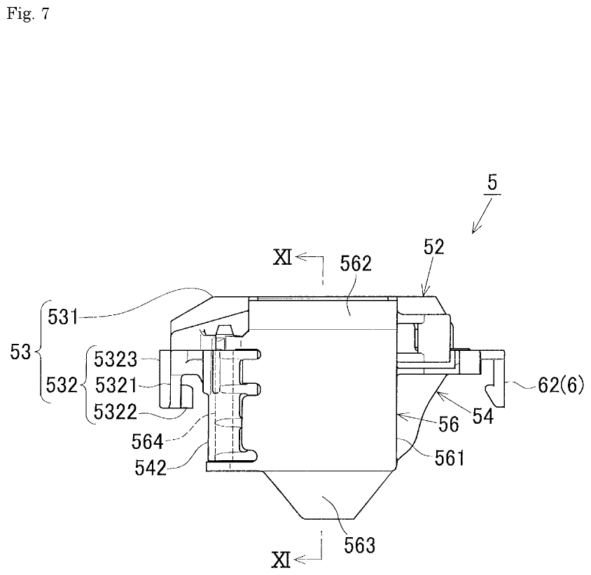

As also shown in FIGS. 7 to 11, the connector 5 includes: a conductor portion 51 which is electrically connected to the energy storage device 10 (specifically, the external terminal 14); a connector main body 52 which holds the conductor portion 51; and a first linking part (linking part) 61 (see FIG. 13) and a second linking part (linking part) 62 which link the connector main body 52 to the terminal member 41. The connector 5 of the present embodiment includes a cover member 56 for preventing the conductor portion 51 from coming into contact with a person during storage, transportation, installation, or the like of the energy storage apparatus 1.

The conductor portion 51 includes a terminal portion 511 which is connected to an external device or the like, and a connecting portion 512 which directly or indirectly connects the terminal portion 511 and the external terminal 14 of the energy storage device in an electrically conductive manner, and is made of a member having conductivity such as metal.

The connecting portion 512 includes: a first plate-shaped portion 5121 which expands in a direction orthogonal to the Z-axis direction; a second plate-shaped portion 5122 which expands in a direction orthogonal to the X-axis direction; and a bent portion 5123 which connects an end portion of the first plate-shaped portion 5121 on a side (outer side) opposite to the side of the energy storage device 10 in the X-axis direction and one end portion of the second plate-shaped portion 5122 in the Z-axis direction. The connecting portion 512 of the present embodiment is formed by bending a central portion in the longitudinal direction of a plate-shaped member having a predetermined shape.

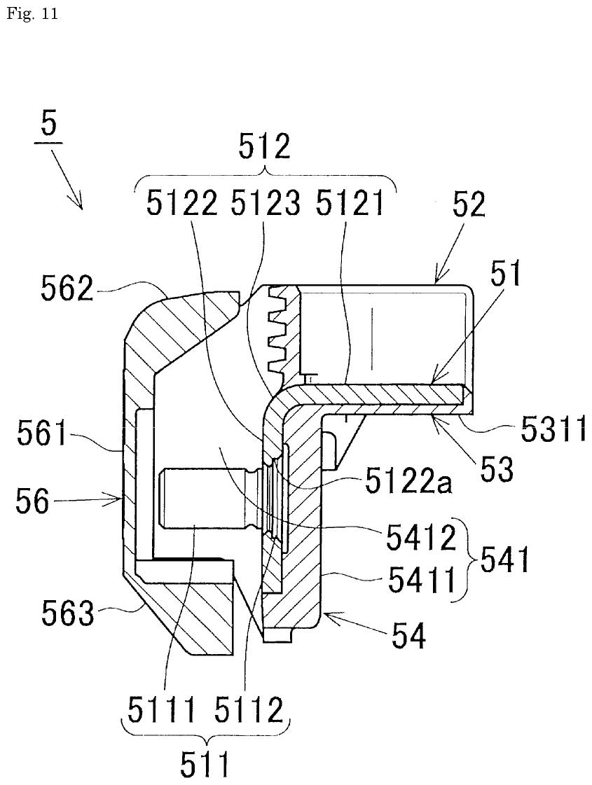

The first plate-shaped portion 5121 is a portion to which the bus bar 8 is connected, and is a rectangular portion elongated in the Y-axis direction. The bus bar 8 electrically connected to the external terminal 14 of the energy storage device 10 located at the outermost end in the X-axis direction, among the plurality of energy storage devices 10 arranged in the X-axis direction, is connected to the first plate-like portion 5121 of the present embodiment. The second plate-shaped portion 5122 is a portion where the terminal portion 511 is disposed, and includes a through hole penetrating in the X-axis direction at the center portion. In the second plate-shaped portion 5122, an inner peripheral surface 5122a (see FIG. 11) which defines the through hole has a tapered shape in which a diameter decreases with distance from the energy storage device 10 in the X-axis direction.

The terminal portion 511 includes a shaft 5111 extending in the X-axis direction and a fixing portion 5112 extending from one end portion of the shaft 5111 in a direction orthogonal to the X axis.

The shaft 5111 extends in the X-axis direction from the second plate-shaped portion 5122 in a state of being inserted into the through hole (through hole defined by the inner peripheral surface 5122 a) of the second plate-shaped portion 5122. The shaft 5111 of the present embodiment has a columnar shape, and a male screw is formed on a peripheral surface thereof.

The fixing portion 5112 has a shape corresponding to the inner peripheral surface 5122a of the second plate-shaped portion 5122, and is fixed to the second plate-shaped portion 5122 (more specifically, the inner peripheral surface 5122a). The fixing portion 5112 of the present embodiment has a tapered shape (that is, the shape in which the diameter increases toward the energy storage device 10 in the X-axis direction) corresponding to the inner peripheral surface 5122a.

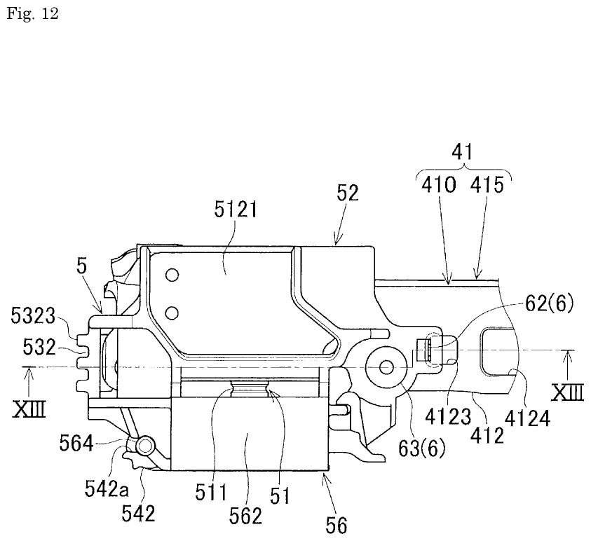

As also illustrated in FIGS. 12 and 13, the connector main body 52 is attached to the terminal member 41 in a state of holding the conductor portion 51. The connector main body 52 is formed of an insulating member such as resin, and insulates the conductor portion 51 and the terminal member 41 from each other. Specifically, the connector main body 52 includes a first portion 53 partially or entirely located between the first plate-shaped portion 5121 and the flange portion 412 in the Z-axis direction, and a second portion 54 partially or entirely located between the second plate-shaped portion 5122 and the first member body 411 in the X-axis direction. The connector main body 52 is attached to one end (an end on the first through hole 4121 side) of the flange portion 412 in the Y-axis direction.

The first portion 53 includes a first portion body 531 which expands along the first plate-shaped portion 5121 and holds the first plate-shaped portion 5121, and an engaging portion 532 which extends from the first portion body 531 and engages with an end portion of the flange portion 412 in the Y-axis direction.

The first portion body 531 includes a contact surface 5311 which expands in a direction orthogonal to the Z-axis direction and is brought into contact with the flange portion 412. The first portion body 531 is disposed at a position overlapping a region from one end portion (end portion on the first through hole 4121 side) of the flange portion 412 in the Y-axis direction to the third through hole 4123 when viewed from the Z-axis direction. The first portion body 531 has a linking through portion 5312 penetrating in the Z-axis direction at one end portion in the Y-axis direction (on the center C side in the Y-axis direction of the terminal member 41). The linking through portion 5312 is disposed at a position overlapping the second through hole 4122 of the flange portion 412 as viewed in the Z-axis direction.

The engaging portion 532 is a hook-shaped portion extending from the first portion body 531 when viewed from the X-axis direction. Specifically, the engaging portion 532 includes a first extending portion 5321 extending from the first portion body 531 toward the other side in the Z-axis direction through a position adjacent to an end edge of the flange portion 412 in the Y-axis direction, and a second extending portion 5322 extending from the first extending portion 5321 in the Y-axis direction along a surface of the flange portion 412 facing the other side in the Z-axis direction. The engaging portion 532 of the present embodiment has a plurality of projecting ridges 5323 which project from the outer surfaces of the first extending portion 5321 and the second extending portion 5322 (the surfaces opposite to the flange portion 412 side), extend from one end of the first extending portion 5321 in the Z-axis direction to the tip of the second extending portion 5322, and are disposed at intervals in the X-axis direction. The plurality of projecting ridges 5323 ensure the strength of the engaging portion 532.

The second portion 54 includes a second portion body 541 which expands along the second plate-shaped portion 5122 and holds the second plate-shaped portion 5122, and a holding part 542 which rotatably holds the cover member 56.

The second portion body 541 includes a base portion 5411 extending in the Z-axis direction from the first portion body 531 along the second plate-shaped portion 5122, and a pair of walls 5412 extending in the X-axis direction from the base portion 5411 on both sides of the second plate-shaped portion 5122 in the Y-axis direction.

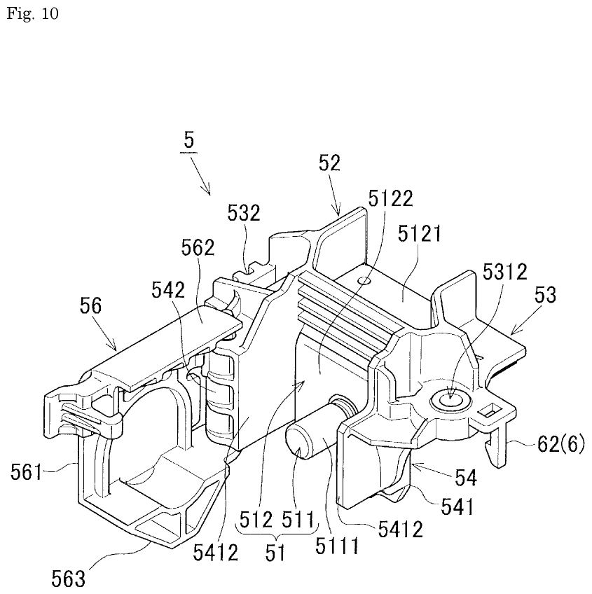

The base portion 5411 extends from an end portion in the X-axis direction of the contact surface 5311 of the first portion body 531 toward the other side in the Z-axis direction and extends in the Y-axis direction. Each of the pair of walls 5412 extends in the X-axis direction and in the Z-axis direction from positions of the base portion 5411 at a distance corresponding to the second plate-shaped portion 5122 in the Y-axis direction. The dimension of the pair of walls 5412 in the X-axis direction is larger than the dimension from the second plate-shaped portion 5122 to a tip of the terminal portion 511 (specifically, the shaft 5111). The holding part 542 is disposed at a tip portion in the X-axis direction of one wall (left wall in FIG. 10) 5412 of the pair of walls 5412. The holding part 542 of the present embodiment has a columnar inner peripheral surface 542a (see FIG. 12) extending in the Z-axis direction and partially opened in the circumferential direction.

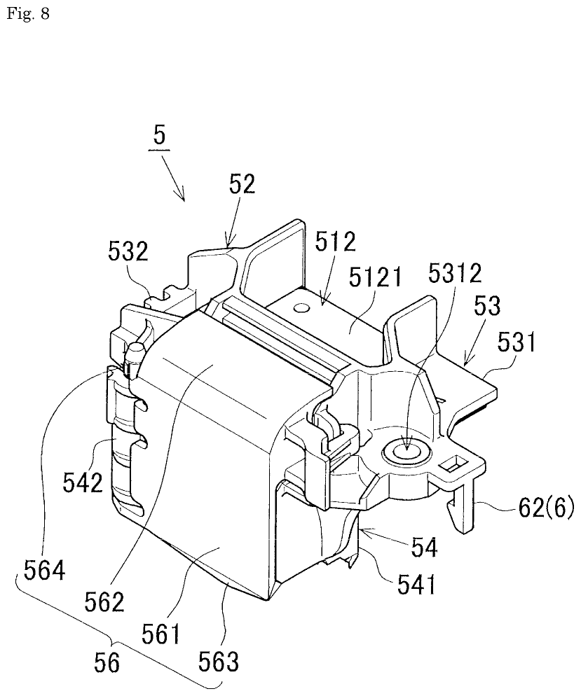

The cover member 56 is rotatably attached to the connector main body 52 between an open position (a position illustrated in FIG. 10) where the terminal portion 511 is opened to be accessible from the outside and a closed position (a position illustrated in FIG. 8) where the terminal portion 511 is hidden.

The cover member 56 includes, in the state of the closed position, a plate-shaped first cover portion 561 which expands in a direction orthogonal to the X-axis direction, a second cover portion 562 which extends in a direction approaching the energy storage device 10 from one end portion of the first cover portion 561 in the Z-axis direction, a third cover portion 563 which extends so as to be positioned at the other side in the Z-axis direction as it approaches the energy storage device 10 from the other end portion of the first cover portion 561 in the Z-axis direction, and a held part 564 which is disposed at the end portion of the first cover portion 561 in the Y-axis direction and is held by the holding part 542 of the connector main body 52.

The held part 564 is a columnar portion corresponding to the inner peripheral surface 542a of the holding part 542 of the connector main body 52, that is, a columnar portion extending in the Z-axis direction, and is rotatably held around the held part 564 by the holding part 542.

The first linking part 61 is formed of a protruding part which protrudes toward the other side in the Z-axis direction from the contact surface 5311 of the connector main body 52 (specifically, the first portion body 531). To be more specific, the first linking part 61 is a columnar portion which protrudes (extends) from a position which faces the first through hole 4121 of the flange portion 412 on the contact surface 5311, and is inserted into the first through hole 4121. In the present embodiment, the diameter of the first linking part 61 is slightly larger than the minor axis of the first through hole 4121, and the first linking part 61 is press-fitted (engaged) into the first through hole 4121.

The second linking part 62 is formed of a protruding part which protrudes toward the other side in the Z-axis direction from the contact surface 5311 of the connector main body 52. Specifically, the second linking part 62 is a locking piece protruding (extending) from a position facing the third through hole 4123 of the flange portion 412 on the contact surface 5311, and has a claw shape in which the tip portion is engaged with a peripheral edge portion of the through hole of the third through hole 4123. When the connector 5 is attached to the flange portion 412, the second linking part 62 has a shape in which the tip portion is engaged with the peripheral edge portion of the through hole of the third through hole 4123 by being inserted (pushed) into the third through hole 4123 from one side toward the other side in the Z-axis direction to a position where the tip portion passes through the third through hole 4123.

The first linking part 61 and the second linking part 62 configured as described above are made of resin, and are integrally molded with the connector main body 52. In the energy storage apparatus 1 of the present embodiment, the first linking part 61 and the second linking part 62 are included in the plurality of linking parts 6.

Three or more linking parts 6 are disposed, and the three or more linking parts 6 include three or more types of linking parts 61, 62, and 63 having different configurations. The plurality of linking parts 6 include at least one linking part 61 or 62 made of resin. In the energy storage apparatus 1 of the present embodiment, the plurality of linking parts 6 include two resin linking parts (first linking part 61, second linking part 62). The plurality of linking parts 6 include at least one metallic linking part 63. In the energy storage apparatus 1 of the present embodiment, the plurality of linking parts 6 include one metallic linking part (third linking part) 63.

The third linking part 63 includes a through shaft 631 which penetrates the connector 5 and the terminal member 41 and extends in the penetrating direction (see FIG. 13). The third linking part 63 links the connector 5 and the terminal member 41 so that the connector 5 can rotate with respect to the terminal member 41 about the through shaft 631 as a rotation center. To be more specific, the through shaft 631 of the third linking part 63 is a shaft which extends in the Z-axis direction, and is engaged with the connecting through portion 5312 of the connector main body 52 (specifically, the first portion body 531) by being inserted into the second through hole 4122 of the flange portion 412. The third linking part 63 of the present embodiment is a so-called rivet.

The insulator 7 has an insulating property. The insulator 7 is disposed between the extending member 42 and the plurality of energy storage devices 10. To be specific, the energy storage apparatus 1 includes a pair of insulators 7, and each insulator 7 covers at least a region of the extending member 42 which faces the plurality of energy storage devices 10. With such a configuration, each insulator 7 provides insulation between the extending member 42 and the plurality of energy storage devices 10. A through hole 71 having a size and a shape corresponding to each through hole 4201 of the extending member body 420 is provided at each position corresponding to each through hole 4201 of the extending member body 420 in each insulator 7.

Each of the plurality of bus bars 8 is a plate-like member having conductivity such as metal. Each of the bus bars 8 makes the external terminals 14 of the energy storage devices 10 conductive with each other or makes the external terminal 14 of the energy storage device 10 and the conductor portion 51 (specifically, the first plate-shaped portion 5121 of the connecting portion 512) of the connector 5 conductive with each other. The plurality of bus bars 8 of the present embodiment connect (conduct) the plurality of energy storage devices 10 included in the energy storage apparatus 1 in series. Each of the bus bars 8 is welded to the external terminal 14 or the conductor portion 51 (specifically, the first plate-shaped portion 5121) of the connector.

In the energy storage apparatus 1 having the above-mentioned configuration, at the time of assembling or the like, the connector 5 is mounted on the terminal member 41 in the following manner.

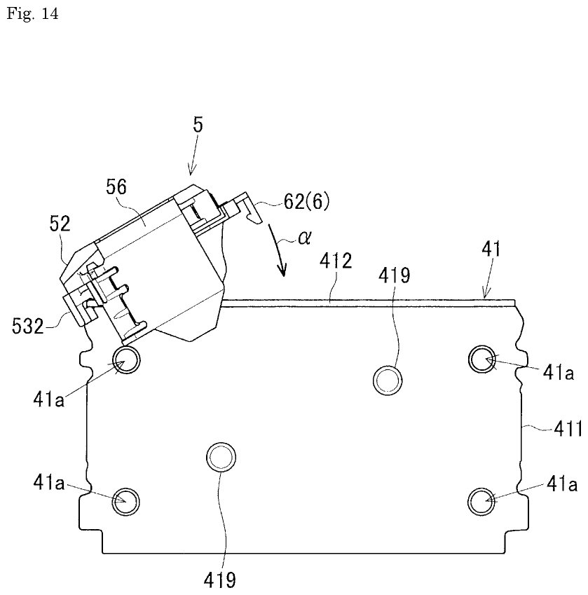

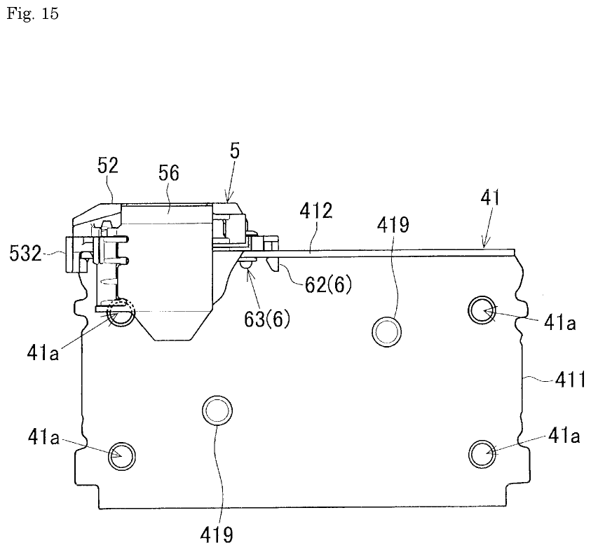

In a state where the hook-shaped engaging portion 532 of the connector main body 52 is hooked on the end portion of the flange portion 412 in the Y-axis direction (see FIG. 14), the connector main body 52 is rotated about the hooked position as a rotation center (see an arrow a in FIGS. 14 and 15). At this time, the first linking part 61 is press-fitted into the first through hole 4121, and the second linking part 62 is engaged with the peripheral edge portion of the through hole of the third through hole 4123. When the linking part 6 (first linking part 61, second linking part 62) made of resin links (that is, temporary fixing) the connector main body 52 and the flange portion 412 of the terminal member 41 in this manner, the portions of the connector main body 52 and the flange portion 412 of the terminal member 41 linked by the third linking part (rivet) 63 are positioned, that is, the linking through portion 5312 of the connector main body 52 and the second through hole 4122 of the flange portion 412 overlap each other as viewed in the Z-axis direction.

Subsequently, riveting is performed in a state where the through shaft 631 of the third linking part (rivet) 63 is inserted through the linking through portion 5312 of the connector main body 52 and the second through hole 4122 of the flange portion 412. With such a configuration, the connector 5 is mounted on the flange portion 412 of the terminal member 41.

Next, the external terminal 14 of the energy storage device 10 disposed adjacently to the terminal member 41 to which the connector 5 is attached via the third adjacent member 2C interposed therebetween and the connecting portion 512 (specifically, the first plate-shaped portion 5121) of the connector 5 are connected by the bus bar 8. Accordingly, attachment of the connector 5 is completed.

In a state where the connector 5 is attached to the terminal member 41 as described above, the connector 5 is disposed at a position where the terminal member 41 is sandwiched between the connector 5 and the energy storage device 10 in the X-axis direction and at a position where a part or the whole of the connector 5 overlaps with the terminal member 41 as viewed in the X-axis direction. Apart or all of the linking member 43 (specifically, the bolt 431) linking the terminal member 41 and the extending member 42 is located between the terminal member 41 and the connector 5 and is disposed at a position overlapping the connector 5 as viewed in the X-axis direction.

On the other hand, when the energy storage apparatus 1 is disassembled, first, the bus bar 8 connected to the connecting portion 512 of the connector 5 is removed, and the engaging portion 532 and the second linking part 62 of the connector 5 are cut by a cutting tool such as a nipper. Then, by lifting the end portion of the connector main body 52 on the first linking part 61 side with respect to the flange portion 412, the first linking part 61 is pulled out from the first through hole 4121, and in this state, the connector main body 52 is rotated about the through shaft 631 of the third linking part 63 as a rotation center. With such a configuration, the linking member 43 (specifically, the head of the bolt 431) covered by the connector 5 is exposed when viewed in the X-axis direction and hence, the linking member 43 can be detached whereby the holding member 4 can be disassembled.

According to the energy storage apparatus 1 described above, since at least one linking part (in the example of the present embodiment, the second linking part 62) of the plurality of linking parts 6 is a resin-made linking part which can be easily broken or the like by a cutting tool such as a nipper, the energy storage apparatus 1 is easily disassembled.

In the energy storage apparatus 1 of the present embodiment, the connector 5 includes the conductor portion 51 including the terminal portion (terminal) 511 having conductivity, and the connector main body 52 made of resin and holding the conductor portion 51. The first linking part 61 made of resin is formed of a protruding part extending from the connector main body 52, and the terminal member 41 has the first through hole 4121 at a position corresponding to the first linking part (protruding part) 61. The first linking part 61 extending from the connector main body 52 is press-fitted into the first through hole 4121 of the terminal member 41. Accordingly, the first linking part 61 formed of the protruding part can be easily removed (that is, linking by the first linking part 61 is released) from the terminal member 41 (specifically, the flange portion 412) by being pulled out from the first through hole 4121 of the terminal member 41. In addition, since the first linking part (protruding part) 61 extends from the connector main body 52, it is possible to suppress occurrence of falling, loss, or the like of the first linking part (protruding part) 61 after being pulled out from the terminal member 41.

The second linking part (protruding part) 62 extending from the connector main body 52 is engaged with the peripheral edge portion of the through hole of the third through hole 4123 in a state of being inserted into the third through hole 4123 of the terminal member 41. According to such a configuration, since the protruding part (locking piece) forming the second linking part 62 is made of resin, the second linking part (locking piece) 62 can be easily broken or the like. This facilitates disassembly of the energy storage apparatus 1.

The energy storage apparatus 1 of the present embodiment includes: the extending member 42 which extends in the X-axis direction along at least one energy storage device 10; and the linking member 43 which links the terminal member 41 and the extending member 42 to each other. In the energy storage apparatus 1, the connector 5 is disposed at a position where the terminal member 41 is sandwiched between the connector 5 and the energy storage device 10 in the X-axis direction and at a position where a part or the whole of the connector 5 overlaps the terminal member 41 as viewed in the X-axis direction, and a part or the whole of the linking member 43 at a position corresponding to the connector 5 is positioned between the terminal member 41 and the connector 5 and at a position overlaps with the connector 5 as viewed in the X-axis direction. One linking part (third linking part) 63 of the plurality of linking parts 6 includes the through shaft 631 penetrating the connector 5 and the terminal member 41 and extending in the penetrating direction, and links the connector 5 and the terminal member 41 so that the connector 5 can rotate with respect to the terminal member 41 about the through shaft 631 as a rotation center.

With such a configuration, the links between the terminal member 41 and the extending member 42 can be released without releasing all the links formed by the plurality of linking parts 6 and hence, the energy storage apparatus 1 can be easily disassembled. That is, in the energy storage apparatus 1, the linking member (linking member at the position corresponding to the connector 5) 43 is hidden by the connector main body 52, but when the third linking part 63 including the through shaft 631 is left and the links by the other linking parts 61 and 62 are released, the connector 5 can be rotated about the through shaft 631 with respect to the terminal member 41 to expose the linking member 43. As a result, an operator or the like can easily access the linking member 43, so that the links between the terminal member 41 and the extending member 42 can be easily released.

In the energy storage apparatus 1 of the present embodiment, the plurality of linking parts 6 include at least one metallic linking part 63. As described above, since the plurality of linking parts 6 include the resin linking parts 61 and 62 and the metallic linking part 63, it is easy to balance ease of disassembly and securing of linking strength.

The third metallic linking part 63 of the present embodiment is a rivet, and the resin linking parts (first linking part 61, second linking part 62) link the connector 5 and the terminal member 41 so that the portions of the connector 5 and the terminal member 41 linked by the rivet 63 are positioned (that is, the linking through portion 5312 of the connector 5 and the second through hole 4122 of the flange portion 412 overlap each other.). Therefore, the energy storage apparatus 1 can be easily assembled. That is, when the energy storage apparatus 1 is assembled, the connector 5 and the terminal member 41 are linked to each other by at least one resin linking part (In the example of the present embodiment, the first linking part 61 and the second linking part 62) so that the portions 5312 and 4122 of the connector 5 and the terminal member 41 linked to each other by the rivet 63 are positioned and hence, linking by the rivet 63 can be easily performed.

It is needless to say that the energy storage apparatus of the present invention is not limited to the above-mentioned embodiment, and various modifications can be made within the scope not departing from the gist of the present invention. The configuration of another embodiment can be added to the configuration of one embodiment, and a part of the configuration of one embodiment can be replaced with the configuration of another embodiment. Apart of the configuration of an embodiment can be deleted.

In the energy storage apparatus 1 of the above embodiment, the plurality of linking parts 6 include the linking parts 61 and 62 made of resin and the linking part 63 made of metal, but the present invention is not limited to this configuration. All of the plurality of linking parts 6 may be made of resin.

In the energy storage apparatus 1 of the above-mentioned embodiment, the first linking part 61 is press-fitted into the first through hole 4121 of the terminal member 41, the second linking part 62 has a claw shape whose tip portion is engaged with the peripheral edge portion of the through hole of the third through hole 4123, and the through shaft 631 of the third linking part 63 is inserted into the linking through portion 5312 and the second through hole 4122. However, the present invention is not limited to this configuration. The linking parts (first linking part 61, second linking part 62, third linking part 63) can be engaged with the peripheral edge portions of the through holes (first through hole 4121, third through hole 4123, second through hole 4122) only by being in contact with the peripheral edge portions.

In the energy storage apparatus 1 of the above-mentioned embodiment, the plurality of linking parts 6 include the three types of linking parts 61, 62 and 63 having different configurations from each other. However, the present invention is not limited to this configuration. The plurality of linking parts 6 may include two or four or more linking parts. The plurality of linking parts 6 may include linking parts having the same configuration. The plurality of linking parts 6 may include four or more types of linking parts having different configurations. The plurality of linking parts 6 may include two or more metallic linking parts as long as the plurality of linking parts 6 include at least one resin linking part.

In the energy storage apparatus 1 of the above-mentioned embodiment, the linking part (third linking part) 63 made of metal links the connector 5 and the terminal member 41 to each other in a rotatable manner about the through shaft 631. However, the present invention is not limited to this configuration. The metallic linking part 63 may link the connector 5 and the terminal member 41 in a state where the connector 5 cannot rotate with respect to the terminal member 41.

Although the energy storage apparatus 1 of the above-mentioned embodiment includes the two connectors 5, that is, the connector 5 on the positive electrode side and the connector 5 on the negative electrode side, the energy storage apparatus 1 is not limited to this configuration. The energy storage apparatus 1 may include one connector 5.

In the energy storage apparatus 1 of the above-mentioned embodiment, the terminal member 41 is formed of two members (first member 410 and second member 415). However, the present invention is not limited to this configuration. The terminal member 41 may be formed of one member or three or more members.

In the energy storage apparatus 1 of the above-mentioned embodiment, the connector 5 is mounted on the flange portion 412 of the terminal member 41. However, the present invention is not limited to this configuration. The connector 5 only needs to be attached to the terminal member 41, and a portion to be attached is not limited.

In the energy storage apparatus 1 of the above-mentioned embodiment, in the connector 5, the first linking part 61 and the second linking part 62 are formed integrally with the connector main body 52. However, the present invention is not limited to this configuration. All of the plurality of linking parts 6 may be separated from the connector main body 52. All of the plurality of linking parts 6 may be formed integrally with the connector main body 52.

In the energy storage apparatus 1 of the above-mentioned embodiment, in the connector 5, the terminal portion 511 which is connected to the external equipment or a different energy storage apparatus 1 is formed of a member which is formed separately from the member (bus bar 8) directly connected to the external terminal 14 of the energy storage device 10, but the present invention is not limited to this configuration. A member (bus bar 8) connected to the external terminal 14 of the energy storage device 10 may form the terminal portion 511 of the connector 5. In this case, the connector main body 52 holds the member. That is, the connector main body 52 is a conductor (terminal) disposed at an end of an electric circuit (the plurality of energy storage devices 10 connected in series) formed in the energy storage apparatus 1, and holds a conductor to which an external device or the like is connected.

In the above embodiment, the case where the energy storage device is used as a chargeable/dischargeable nonaqueous electrolyte secondary battery (for example, a lithium ion secondary battery) has been described, but the type and size (capacity) of the energy storage device are arbitrary. In the above embodiment, the lithium ion secondary battery has been described as an example of the energy storage device, but the present invention is not limited thereto. The present invention is also applicable to various secondary batteries, primary batteries, and energy storage devices of capacitors such as electric double layer capacitors.

### DESCRIPTION OF REFERENCE SIGNS

1: energy storage apparatus
2: adjacent member
2A: first adjacent member
2B: second adjacent member
2C: third adjacent member
4: holding member
41: terminal member
41a: linking through hole
410: first member
411: first member body
4111: first linking through hole
4112: fixing through hole
412: flange portion
4121: first through hole
4122: second through hole
4123: third through hole
4124: fourth through hole
415: second member
4161: second linking through hole
4162: protruding part
419: fixing portion
4191: shaft
4192: head portion
42: extending member
420: extending member body
4201: through hole
421: first piece part
422: second piece part
423: third piece part
4231: through hole
43: linking member
431: bolt
432: nut
5: connector
51: conductor portion
511: terminal portion
5111: shaft
5112: fixing portion
512: connecting portion
5121: first plate-shaped portion
5122: second plate-shaped portion
5122a: inner peripheral surface
5123: bent portion
52: connector main body
53: first portion
531: first portion body
5311: contact surface
5312: linking through portion
532: engaging portion
5321: first extending portion
5322: second extending portion
5323: projecting ridge
54: second portion
541: second portion body
5411: base portion
5412: wall
542: holding part
542a: inner peripheral surface
56: cover member
561: first cover portion
562: second cover portion
563: third cover portion
564: held part
6: linking part
61: first linking part
62: second linking part
63: third linking part (rivet)
631: through shaft
7: insulator
71: through hole
8: bus bar
10: energy storage device
11: case
12: case body
121: closing part
122: body part
123: long wall
124: short wall
13: lid plate
14: external terminal
900: terminal block
901: mounting table
901a: groove
901b, 901c: through hole
901d: screw hole
902: member
902a, 902b, 902c: through hole
905A: bus bar
905C: external bus bar
906, 908: screw
910: upper case
B: first fastening member
C: center of terminal member in Y-axis direction
H1, H2: through hole
R: flow path

1. An energy storage apparatus comprising:
at least one energy storage device;
a terminal member aligned with the at least one energy storage device in a predetermined direction;
a connector which is connected to the at least one energy storage device in an electrically conductive manner and performs electrical input and output with an outside; and
a plurality of linking parts which fix the connector to the terminal member, wherein the plurality of linking parts include at least one linking part made of resin.

2. The energy storage apparatus according to claim 1, wherein
the connector includes a terminal having conductivity, and a connector main body made of resin and holding the terminal,
the at least one linking part made of resin is formed of a protruding part extending from the connector main body,
the terminal member includes a through hole at a position corresponding to the protruding part, and
the protruding part extending from the connector main body is engaged with a peripheral edge portion of the through hole in a state where the protruding part is inserted into the through hole of the terminal member.

3. The energy storage apparatus according to claim 1 or 2, further comprising:
an extending member extending in the predetermined direction along the at least one energy storage device; and
a linking member which links the terminal member and the extending member, wherein
the terminal member is disposed between the at least one energy storage device and the connector in the predetermined direction,
a part or whole of the connector is disposed at a position overlapping the terminal member when viewed from the predetermined direction,
a part or whole of the linking member is located between the terminal member and the connector, and is disposed at a position overlapping the connector when viewed from the predetermined direction, and
one linking part of the plurality of linking parts includes a through shaft which penetrates the connector and the terminal member in a penetrating direction and extends in the penetrating direction, and links the connector and the terminal member so as to allow the connector to be rotatable about the through shaft with respect to the terminal member.

4. The energy storage apparatus according to any one of claims 1 to 3, wherein the plurality of linking parts include at least one linking part made of metal.

5. The energy storage apparatus according to claim 4, wherein the at least one linking part made of metal is a rivet, and
the at least one linking part made of resin links the connector and the terminal member so as to position portions of the connector and the terminal member linked to each other by the rivet.

6. The energy storage apparatus according to any one of claims 1 to 5, wherein
three or more of the linking parts are disposed, and
the three or more linking parts include three or more types of linking parts having different configurations.
